(19) United States
(12) Patent Application Publication
(10) Pub. No.: US 2004/0074244 A1
(43) Pub. Date: Apr. 22, 2004

(54) Vehicle air-conditioning system

(76) Inventors: Yoshinori Ichishi, Kariya-city (JP); Tatsumi Kumada, Gamagori-city (JP)

Correspondence Address: HARNESS, DICKEY & PIERCE, P.L.C., P.O. BOX 828, BLOOMFIELD HILLS, MI, 48303, US

(21) Appl. No.: 10/682,942

(22) Filed: Oct. 10, 2003

(30) Foreign Application Priority Data
Oct. 11, 2002 (JP) 2002-299206

(51) Int. Cl. F25D 17/04; B60H 1/00; B60H 1/32

(52) U.S. Cl. 62/186; 165/204; 62/244

(57) ABSTRACT

A vehicle air-conditioning system includes a control unit for permitting a non-contact temperature sensor to sense in a non-contact manner the temperatures of sensed regions that constitute the surface of the driver in the passenger compartment. In the presence of a disturbance in a predetermined temperature distribution over the sensed regions, control is provided in accordance with the temperature sensed by the non-contact temperature sensor to the ratio of flow rate or the blower temperature of conditioned air supplied from a blower opening located near the region having the disturbance in the temperature distribution, of a face blower opening, an armrest blower opening, a ceiling blower opening, and a side-window blower opening to thereby eliminate the disturbance in the predetermined temperature distribution over a plurality of regions.

### CROSS REFERENCE TO RELATED APPLICATIONS

This application is based upon, claims the benefit of priority of, and incorporates by reference the contents of Japanese Patent Application No. 2002-299206 filed Oct. 11, 2002.

### BACKGROUND OF THE INVENTION

1. Field of the Invention

The present invention relates generally to a vehicle air-conditioning system and, more particularly, to a vehicle air-conditioning system employing a non-contact temperature sensor to control the conditioned state of the passenger compartment.

2. Description of the Related Art

Conventional vehicle air-conditioning systems employing non-contact temperature sensors are designed to sense the temperature at one portion on the upper body of a driver with an infrared sensor and use this sensed temperature to control the blower temperature or the flow rate of conditioned air discharged toward the driver from a conditioned-air blower opening (e.g., see Japanese Patent Laid-Open Publication No. 2002-172926)

However, variations in the direction of solar radiation received by the passenger compartment prevent the temperature sensed at one portion of the upper body as described above from properly representing the temperature condition of the driver and the driver's surrounding. Accordingly, this prevents proper control of the conditioned state of the passenger compartment and maintenance of the driver's comfort.

Furthermore, such an air-conditioning system that can independently control the blower temperature of each conditioned zones does not permit the temperature sensed at one portion of the upper body to be properly representative of the temperature state of the driver and the driver's surrounding. This may occur when the conditioned zone at the front passenger seat side affects the conditioned zone at the driver seat side or when the passenger in the front seat does not want to be hit by the conditioned air and reduces the flow rate thereof.

### SUMMARY OF THE INVENTION

It is therefore an object of the present invention to provide a vehicle air-conditioning system that can provide a conditioned state in which the passengers feel comfortable.

To achieve the aforementioned object, according to a first aspect of the present invention a vehicle air-conditioning system includes a non-contact temperature sensor (50) for sensing temperatures of a plurality of regions in a passenger compartment in a non-contact manner and control means (4) for controlling a ratio of flow rate or a blower temperature of conditioned air blown out of a plurality of blower openings (100a to 100f) to provide a predetermined temperature distribution for the plurality of regions in accordance with the temperatures of the plurality of regions sensed by the non-contact temperature sensor.

According to a second aspect of the present invention, a vehicle air-conditioning system includes a non-contact temperature sensor (50) for sensing temperatures of a plurality of regions in a passenger compartment in a non-contact manner and control means (4) for controlling a ratio of flow rate or a blower temperature of conditioned air blown out of a plurality of blower openings (100a to 100f) in accordance with the temperatures of the plurality of regions sensed by the non-contact temperature sensor to provide a temperature distribution for the plurality of regions as instructed by a passenger.

Conventional air-conditioning systems that can independently control the blower temperature at each conditioned zone result in a predetermined temperature distribution over the plurality of regions that may become disturbed when a first conditioned zone is influenced by a second conditioned zone adjacent thereto. For example, when a passenger who does not want to be hit by conditioned air reduces the flow rate thereof or the direction of solar radiation received is varied.

In contrast to this conventional system and according to the first and second aspects of the present invention, in the presence of a disturbance in the predetermined temperature distribution over the plurality of regions, the ratio of flow rate or the blower temperature of the conditioned air blown out of the plurality of blower openings is controlled. This allows for elimination of a disturbance in the predetermined temperature distribution to thereby provide a conditioned state in which the passengers feel comfortable.

Furthermore, according to the second aspect of the present invention, the ratio of flow rate or the blower temperature of conditioned air blown out of the plurality of blower openings is controlled to provide a temperature distribution over the plurality of regions as instructed by a passenger. For example, this provides the plurality of regions with a temperature distribution in accordance with the feeling of air speed, the feeling of temperature at the face, or the feeling of temperature at the feet, which are set by a passenger, thus making it possible to realize a target conditioned space by a passenger making the settings.

More specifically, according to a third aspect of the invention, the control means may also control the ratio of flow rate or the blower temperature of conditioned air blown out of a blower opening located near the region, of the plurality of regions, having a disturbance in the temperature distribution.

On the other hand, according to a fourth aspect of the present invention, a vehicle air-conditioning system includes a non-contact temperature sensor (50) for sensing, in a non-contact manner, a temperature of a conditioned zone at an occupied seat in a passenger compartment and control means (4) for controlling a ratio of flow rate or a blower temperature of conditioned air blown out of each of a plurality of blower openings (100a to 100f) to provide a predetermined temperature distribution for the conditioned zone at the occupied seat in accordance with the temperature at the occupied seat sensed by the non-contact temperature sensor.

Here, the conditioned zone at an occupied seat refers to the conditioned zone at the seat occupied by a passenger.

According to the fourth aspect of the invention, in the presence of a disturbance in the predetermined temperature distribution over the conditioned zone at an occupied seat, the ratio of flow rate or the blower temperature of conditioned air blown out of the plurality of blower openings is controlled. This allows for eliminating the disturbance in the temperature distribution, thereby providing a conditioned state in which the passengers feel comfortable.

More specifically, according to a fifth aspect of the present invention, the non-contact temperature sensor may be designed to sense in a non-contact manner the temperatures of the conditioned zone divided into a plurality of regions. Additionally, the control means may also control the ratio of flow rate or the blower temperature of conditioned air blown out of the blower opening located near a region of the plurality of regions having the disturbance in the temperature distribution.

Furthermore, according to a sixth aspect of the present invention, the passenger sets a desired air speed (or feeling of air speed such as higher or lower speed) of air blown out of the plurality of blower openings. When the passenger sets the desired air speed to a lower air speed, the ratio of airflow rate provided by a blower opening of the plurality of blower openings having a larger opening area is increased.

This allows the passenger to have the desired lower air speed because the lower air speed set by the passenger causes the ratio of airflow rate provided by a blower opening of the plurality of blower openings having a larger opening area to be increased.

According to a seventh aspect of the present invention, the passenger sets a desired air speed (such as higher or lower speed) of air blown out of the plurality of blower openings, where lower air speed setting by a passenger causes the ratio of airflow rate provided by a blower opening of the plurality of blower openings located farther away from the passenger to be increased.

This also allows the passenger to have the desired lower air speed because the lower air speed set by the passenger causes the ratio of airflow rate provided by a blower opening of the plurality of blower openings located farther away from the passenger to be increased.

According to an eighth aspect of the present invention, when compared with a steady state period during which the ratio of flow rate or the blower temperature of conditioned air is controlled, in a transient period during which the ratio of flow rate or the blower temperature of conditioned air is controlled, a blower opening having a shorter airflow passageway for conditioned air is selected from the plurality of blower openings, allowing controlled conditioned air to be blown from the selected blower opening.

In the transient period, this allows a blower opening having a shorter airflow passageway to be selected, thereby making it possible to select a blower opening having a lower thermal loss caused by the airflow passageway.

According to a ninth aspect of the present invention, a computer-readable recording medium stores a program for allowing a computer used with a vehicle air-conditioning system to serve as control means (4) in a manner such that a non-contact temperature sensor (50) senses temperatures at a plurality of regions in a passenger compartment and a ratio of flow rate or a blower temperature of conditioned air blown out of a plurality of blower openings (100a to 100f) is controlled in accordance with the temperatures sensed at the plurality of regions to provide a predetermined temperature distribution over the plurality of regions.

According to a tenth aspect of the present invention, a computer-readable recording medium stores a program which allows a computer used with a vehicle air-conditioning system to serve as control means (4) in a manner such that a non-contact temperature sensor (50) senses temperatures of a plurality of regions in a passenger compartment, and a ratio of flow rate or a blower temperature of conditioned air blown out of a plurality of blower openings (100a to 100f) is controlled in accordance with the temperatures sensed at the plurality of regions to provide a temperature distribution over the plurality of regions as instructed by a passenger.

According to an eleventh aspect of the present invention, a computer-readable recording medium stores a program which allows a computer used with a vehicle air-conditioning system to serve as control means (4) in a manner such that a non-contact temperature sensor (50) senses in a non-contact manner a temperature of a conditioned zone at an occupied seat in a passenger compartment, and a ratio of flow rate or a blower temperature of conditioned air blown out of a plurality of blower openings (100a to 100f) is controlled in accordance with the temperature sensed at the occupied seat to provide a predetermined temperature distribution over the conditioned zone at the occupied seat.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The above and other objects, features and advantages of the present invention will become more apparent from the following detailed description made with reference to the accompanying drawings. In the drawings:

FIG. 1 is a view illustrating a vehicle air-conditioning system according to a first embodiment of the present invention;

FIG. 2 is a view illustrating the configuration of the vehicle air-conditioning system of FIG. 1;

FIG. 3 is a view illustrating the location of the non-contact temperature sensor of FIG. 1;

FIG. 4 is a view illustrating the sensing range of the non-contact temperature sensor of FIG. 1;

FIG. 5 is an explanatory flowchart showing the operation of the control unit shown in FIG. 1;

FIG. 6 is an explanatory view showing the operation of the control unit shown in FIG. 1;

FIG. 7 is an explanatory view showing the operation of the control unit shown in FIG. 1;

FIG. 8 is an explanatory flowchart showing the operation of the control unit shown in FIG. 1;

FIG. 9 is an explanatory flowchart showing the operation of the control unit shown in FIG. 1;

FIG. 10 is an explanatory flowchart showing the operation of the control unit shown in FIG. 1;

FIG. 11 is an explanatory flowchart showing the operation of a vehicle air-conditioning system according to a second embodiment of the present invention;

FIG. 12 is an explanatory flowchart showing the operation of the vehicle air-conditioning system according to the aforementioned second embodiment;

FIG. 13 is an explanatory flowchart showing the operation of the vehicle air-conditioning system according to the aforementioned second embodiment;

FIG. 14 is an explanatory flowchart showing the operation of a vehicle air-conditioning system according to a third embodiment of the present invention;

FIG. 15 is an explanatory flowchart showing the operation of the vehicle air-conditioning system according to the aforementioned third embodiment;

FIG. 16 is an explanatory flowchart showing the operation of the vehicle air-conditioning system according to the aforementioned third embodiment; and

FIG. 17 is an explanatory flowchart showing the operation of the vehicle air-conditioning system according to the aforementioned third embodiment.

### DETAILED DESCRIPTION OF THE PREFERRED EMBODIMENTS

The following description of the preferred embodiment(s) is merely exemplary in nature and is in no way intended to limit the invention, its application, or uses.

[First Embodiment]

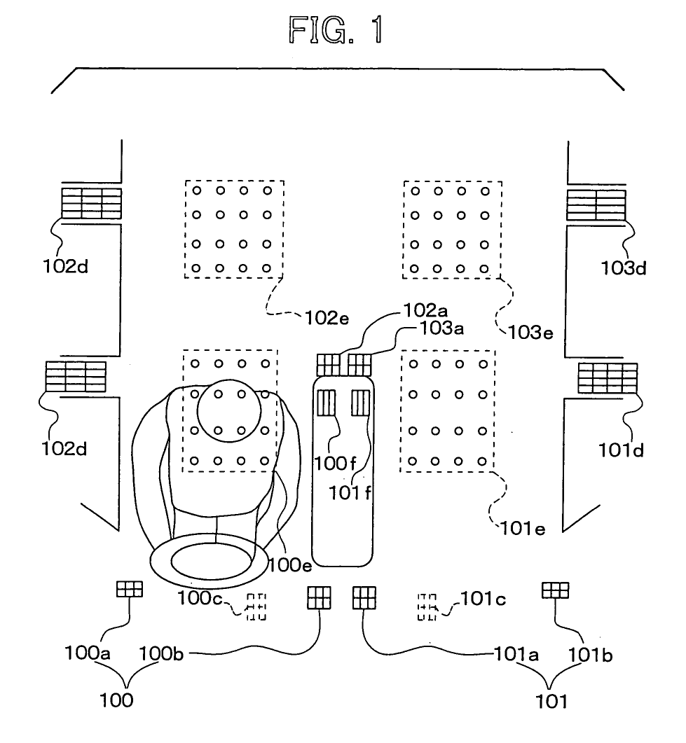

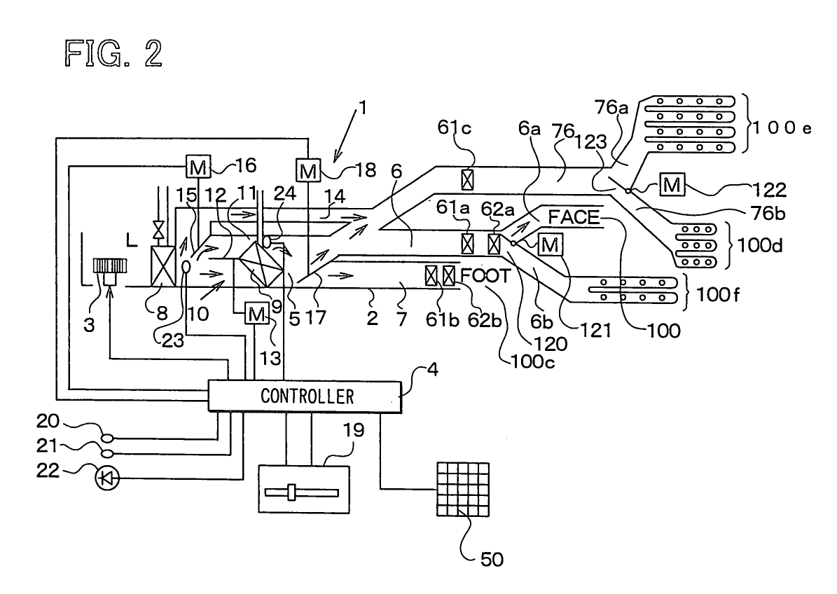

FIGS. 1 and 2 illustrate a vehicle air-conditioning system according to a first embodiment of the present invention, FIG. 1 showing the inside of a passenger compartment into which the vehicle air-conditioning system is incorporated.

The vehicle air-conditioning system includes ceiling blower openings 100e, 101e, 102e, and 103e; side-window blower openings 100d, 101d, 102d, and 103d; and face blower openings 100, 101, 102a, and 103a, corresponding to the driver seat, the front passenger seat, the rear right-side seat, and the rear left-side seat, respectively. The face blower opening 100 includes a side-grille blower opening 100a and a center-grille blower opening 100b, while the face blower opening 101 includes a center-grille blower opening 101a and a side-grille blower opening 101b.

Additionally, foot blower openings 100c, 101c, and armrest blower openings 100f, 101f are also provided corresponding to the driver seat and the front passenger seat. The temperature and the flow rate of conditioned air blown out of each of such blower openings are independently controlled for each seat.

Since the aforementioned arrangement employs the vehicle air-conditioning systems that are constructed in the same manner for the driver seat and the front passenger seat, the air conditioning control provided by the vehicle air-conditioning system for the driver seat will be described below with reference to FIG. 2. FIG. 2 is a schematic view illustrating the configuration of the vehicle air-conditioning system. No explanation will be given below to the vehicle air-conditioning system for the rear right-side seat and the rear left-side seat.

The vehicle air-conditioning system includes an air conditioning unit 1 for supplying airflow to the passenger compartment. The vehicle air-conditioning system is also equipped upstream of the air conditioning unit 1 with an air blower 3 having an inside/outside air switching box (inside/outside air switching means) for introducing inside air or outside air in a switchable manner into the suction port. The air blower 3 produces airflow, to be directed to the passenger compartment, within a duct 2 of the air conditioning unit 1, where control is provided to the quantity of airflow by means of a control unit 4, discussed later.

The duct 2 of the air conditioning unit 1 includes a main passageway 5 and passageways 6, 7, 76, which are branched from the main passageway 5. The passageway 7 passes airflow from the main passageway 5 to the foot blower opening 100c. The foot blower opening 100c has an opening oriented rearward behind the instrument panel to blow airflow toward the feet of a passenger.

The passageway 6 has passageways 6a, 6b branched therefrom, the passageway 6a passing airflow from the main passageway 5 to the face blower opening 100 (100a, 100b). The face blower opening 100 has an opening behind the instrument panel to blow airflow to the upper body of a passenger. The passageway 6b passes airflow from the main passageway 5 to the armrest blower opening 100f. The armrest blower opening 100f has an opening at the armrest to blow airflow toward the upper body of the driver from the left side of the driver.

The passageway 76 has passageways 76a, 76b branched therefrom, the passageway 76a passing airflow from the main passageway 5 to the ceiling blower opening 100e. The ceiling blower opening 100e blows airflow from the ceiling toward the upper body of the driver in the driver seat. The passageway 76b passes airflow from the main passageway 5 to the side-window blower opening 100d. The side-window blower opening 100d has an opening in B-pillar to blow air flow toward the upper body of the driver from the right side of the driver.

The B-pillar is a pillar that is disposed between the front windshield and the rear windshield to support the roof.

Upstream of the main passageway 5, there is provided an evaporator 8 (cooling means) for cooling air passing through the passageway. The evaporator 8 is a component of a refrigeration cycle, which is controlled by the control unit 4, discussed later, allowing the evaporator 8 to operate.

In the main passageway 5 downstream of the evaporator 8, there is provided a heater core 9 (heating means) for heating air passing through the passageway. The heater core 9 is supplied with coolant water (hot water) from the motor vehicle running engine (not shown) to heat the air passing through the main passageway 5. In the main passageway 5, there is also provided heat control means 10 for adjusting the quantity of heat applied to air by the heater core 9.

The heat control means 10 includes a heat control bypass passageway 11 provided in the main passageway 5 to bypass the heater core 9, and an air mix damper (A/M door) 12 for controlling the flow rate of air passing through the heater core 9 and the flow rate of air passing through the heat control bypass passageway 11. The degree of opening of the air mix damper 12 is controlled by means of an actuator 13 (e.g., servomotor) which is in turn controlled by the control unit 4, discussed later.

The duct 2 includes a cool-air bypass passageway 14 for allowing the cooled air having passed through the evaporator 8 to bypass the heat control means 10 and thus directly flow into the passageway 76. Upstream of the cool-air bypass passageway 14, there is provided a bypass opening/closing damper 15 (cool-air bypass door) for opening and closing the cool-air bypass passageway 14 as well as for controlling the degree of opening thereof. The bypass opening/closing damper 15 is driven by means of an actuator 16 (e.g., servomotor), which is in turn controlled by the control unit 4, discussed later.

In this arrangement, the airflow passing through the cool-air bypass passageway 14 and the airflow passing through the main passageway 5 are mixed to flow into the passageway 76. This allows the temperature of the airflow introduced into the passageway 76 to be controlled by the heat control means 10, the cool-air bypass passageway 14, the bypass opening/closing damper 15, and so forth.

At the branch of the passageway 6 and the passageway 7, there is provided a passageway opening/closing damper 17 (passageway opening/closing means) for opening the passageway 7 while closing the passageways 6, 76, for closing the passageway 7 while opening the passageways 6, 76, or for opening all the passageways 6, 7, 76. The passageway opening/closing damper 17 is driven by means of an actuator 18 (e.g., servomotor), which is in turn controlled by the control unit 4, discussed later.

Furthermore, at the branch of the passageway 6a and the passageway 6b in the passageway 6, there is provided an airflow rate control damper 120 for controlling the flow rate of air passing through the passageway 6a and the flow rate of air passing through the passageway 6b. The airflow rate control damper 120 is driven by means of an actuator 121, which is in turn controlled by the control unit 4, discussed later. Additionally, upstream of the airflow rate control damper 120 in the passageway 6, there are provided an auxiliary heater (more specifically, a PTC heater) 61a and an auxiliary cooling device (more specifically, a Peltier element) 62a.

In this arrangement, the auxiliary heater 61a applies heat to the airflow passing through the passageway 6 with its radiator fins, and the auxiliary cooling device 62a absorbs heat from the airflow passing through the passageway 6 to dispose of the heat outside of the passageway 6. The auxiliary heater 61a and auxiliary cooling device 62a are preferably controlled by the control unit 4.

In the passageway 7, there are also provided an auxiliary heater (more specifically, a PTC heater) 61b and an auxiliary cooling device (more specifically, a Peltier element) 62b. The auxiliary heater 61b uses its radiator fins to heat the airflow passing through the passageway 7, and the auxiliary cooling device 62b absorbs heat from the airflow passing through the passageway 7 to dispose of the heat outside of the passageway 7. The control unit 4 also preferably controls the auxiliary heater 61b and the auxiliary cooling device 62b.

At the branch of the passageway 76a and the passageway 76b in the passageway 76, there is provided an airflow rate control damper 123 for controlling the flow rate of air passing through the passageway 76a and the flow rate of air passing through the passageway 76b. The airflow rate control damper 123 is driven by means of an actuator 122, which is in turn controlled by the control unit 4, discussed later. Additionally, upstream of the airflow rate control damper 123 in the passageway 76, there is provided an auxiliary heater (more specifically, a PTC heater) 61c. The auxiliary heater 61c uses its radiator fins to apply heat to the airflow passing through the passageway 76. The control unit 4 preferably controls the auxiliary heater 61c.

The control unit 4 incorporates a computer to controllably energize each electric component of the vehicle air-conditioning system in response to the state of control provided by a passenger and the input values from various sensors. The control unit 4 includes a control panel (not shown) for receiving control provided by a passenger. The control panel has a temperature-setting device 19 for setting a set point temperature in the passenger compartment in addition to an automatic air conditioner switch (not shown) and a switch (not shown) for switching between each of various modes.

The various sensors incorporated in the vehicle air-conditioning system include an outside air sensor 21 for sensing the temperature of air outside the passenger compartment, a solar radiation sensor 22 for sensing the quantity of solar radiation received by the passenger compartment, an after-evaporator sensor 23 for sensing the temperature of air having passed through the evaporator 8, and a water temperature sensor 24 for sensing the temperature of coolant water in the heater core 9.

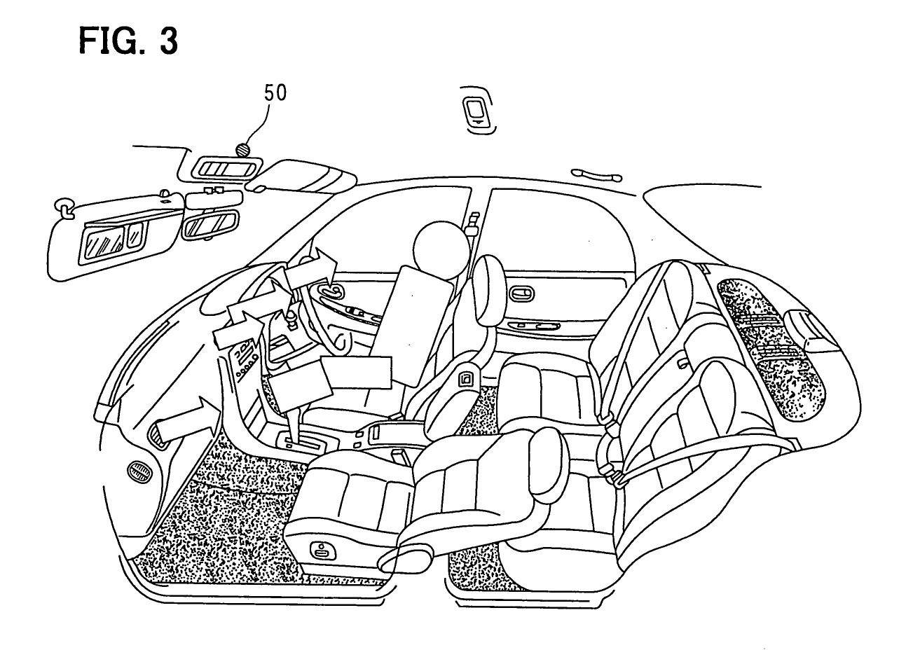

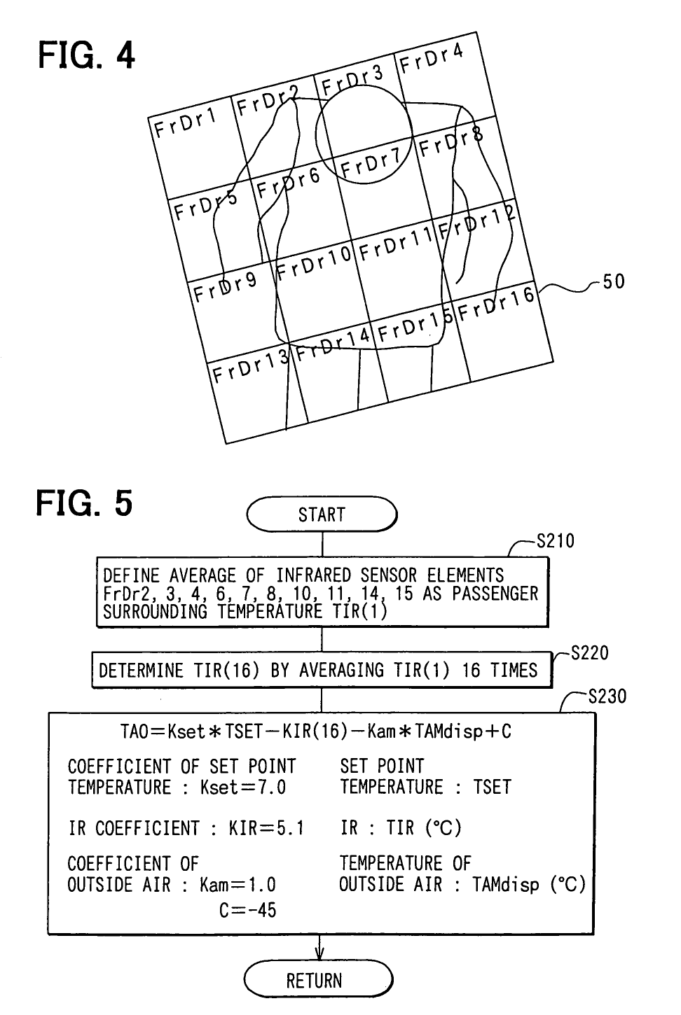

The vehicle air-conditioning system includes a non-contact temperature sensor 50 (e.g., thermopile sensing element), which is located near the rear-view mirror in the passenger compartment as shown in FIG. 3 and oriented to the driver as shown in FIG. 4.

The non-contact temperature sensor 50 has a plurality of infrared sensor elements FrDr1 to FrDr16 arranged in a two-dimensional array, allowing each infrared sensor element to sense each temperature at a plurality of regions constituting the surface of the driver and the driver's surrounding. More specifically, the non-contact temperature sensor 50 allows each infrared sensor element to generate an electromotive force corresponding to the infrared radiation received from the surface of the driver and the driver's surrounding.

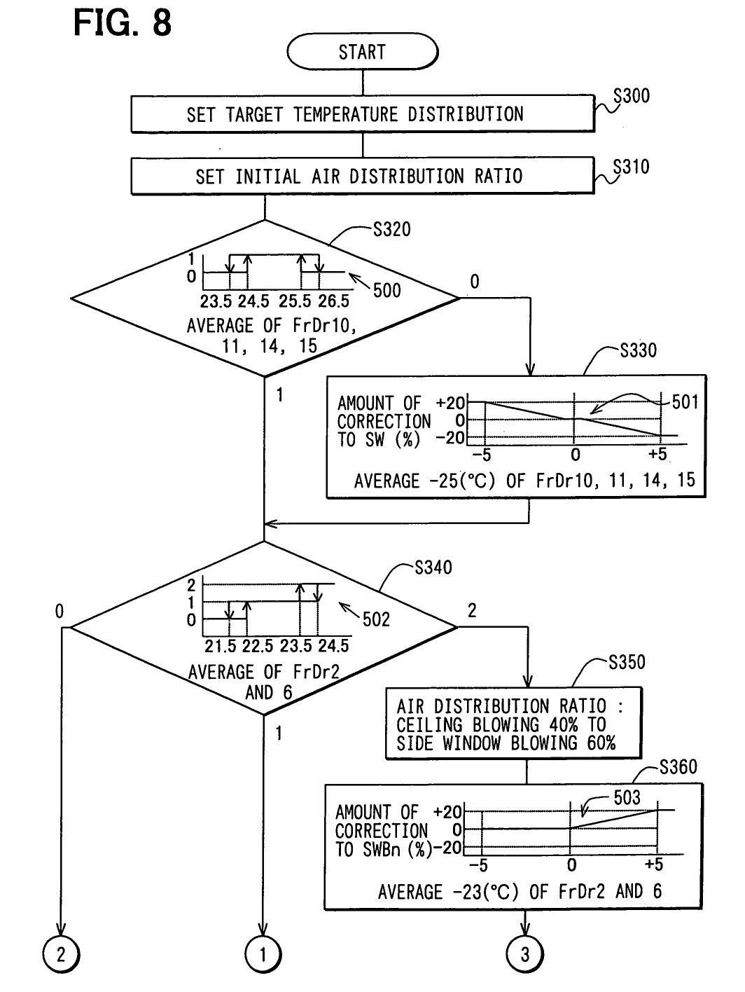

Now, the operation of the first embodiment in the aforementioned arrangement will be described below with reference to the flowcharts illustrated in FIGS. 8 to 10.

When activated, the control unit 4 starts the control program (a computer program) stored in a memory to perform air-conditioning control processing according to the flowcharts shown in FIGS. 5, and 8 to 10.

The air-conditioning control processing includes the basic control processing shown in FIG. 5 and the temperature distribution correction processing shown in FIGS. 8 to 10, the basic control processing and the temperature distribution correction processing being performed alternately.

First, an explanation is given to the basic control processing. The control unit 4 acquires the surface temperatures sensed at the driver by the non-contact temperature sensor 50, or, more specifically, the surface temperatures sensed by each of the infrared sensor elements FrDr2, 3, 4, 6, 7, 8, 10, 11, 14, and 15. The sensed surface temperatures are acquired at certain time intervals (e.g., 250 msec). The surface temperatures sensed by each sensor element are averaged to determine an average temperature (hereinafter referred to as a passenger surrounding temperature TIR(1)) (S210).

Then, the passenger surrounding temperature TIR(1) currently determined and five passenger surrounding temperatures TIR(1) acquired by the processing of S210 being performed five times in the past are averaged to determine an average passenger surrounding temperature TIR(16)(S230).

Then, in accordance with the average passenger surrounding temperature TIR(16), a set point temperature TSET from the temperature-setting device 19, and a sensed temperature signal TAMdisp from the outside air sensor 21, a required blower temperature TAO is calculated as in the following Equation 1, where Kset (=7.0) is the set point temperature coefficient, Kir (=5.1) is the IR coefficient, Kam (=1.0) is the outside air temperature coefficient, and C (=−45) is the correction constant.

TAO=Kset°TSET−KIR°TIR(16)−Kam°TAMdisp+C [Equation 1]

Then, the control unit 4 determines the blower level (the airflow rate) of the air blower 3 in accordance with the required blower temperature TAO. More specifically, the control unit 4 allows the air blower 3 to blow air at a constant airflow rate during an intermediate range of TAO, whereas air blown at an increased airflow rate as TAO is decreased or increased from the intermediate range. Then, the air blower 3 is controlled so as to produce the quantity of airflow thus determined. It is also possible for a passenger to manually set a target airflow rate.

Then, the control unit 4 substitutes the required blower temperature TAO, the sensed temperature Te from the after-evaporator sensor 23, and the sensed temperature Tw from the water temperature sensor 24 into the following Equation 2 to determine the target value of the degree of opening SW of the air mix damper 12. The process then controls the actuator 15 so that the degree of opening of the air mix damper 12 approaches the target value of the degree of opening SWB determined.

SW={(TAO−Te)/(Tw−Te)}×100 (%) [Equation 2]

Then, in accordance with the average passenger surrounding temperature TIR(16), the solar radiation Ts sensed by the solar radiation sensor 22, and the set point temperature TSET provided by the temperature-setting device 19, the control unit 4 determines the degree of opening SWBn of the bypass opening/closing damper 15 (cooling B/P door; cool-air bypass door).

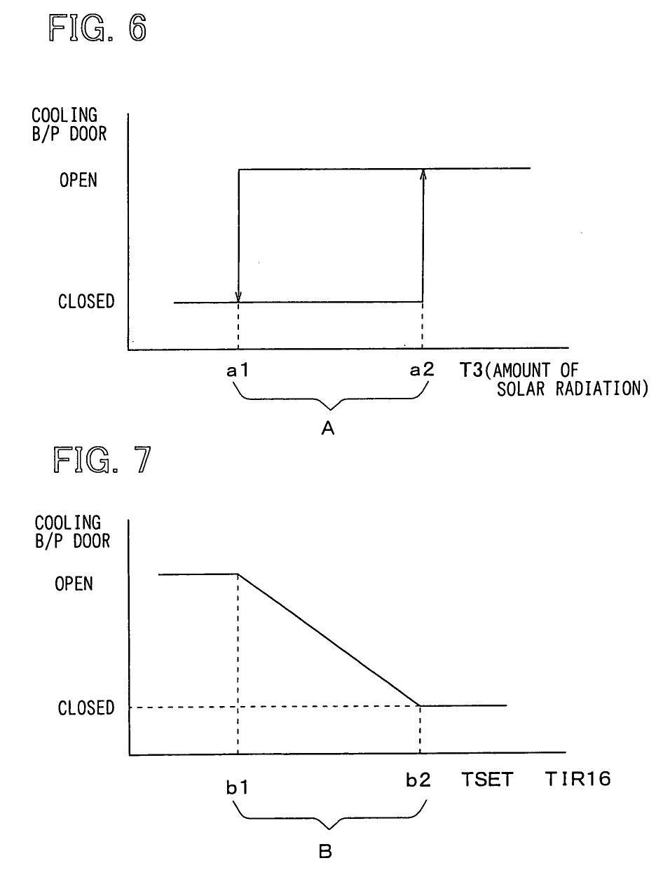

First, as shown in FIG. 6, it is determined whether the bypass opening/closing damper 15 (cooling B/P door; cool-air bypass door) is opened or closed, in accordance with the characteristics having hysteresis for preventing the control hunting. Then, the degree of opening SWBn of the bypass opening/closing damper 15 is determined in accordance with the temperature difference between the set point temperature TSET and the average passenger surrounding temperature TIR(16) (Tset−TIR16).

More specifically, as shown in FIG. 7, when the temperature difference (Tset−TIR16) is less than a predetermined value b1, the bypass opening/closing damper 15 is opened at a ratio of 100% of the degree of opening SWBn. The degree of opening SWBn is gradually decreased as the temperature difference (Tset−TIR16) approaches from the predetermined value b1 to a predetermined value b2 that is greater than the predetermined value b1. Furthermore, when the temperature difference (Tset−TIR16) is greater than the predetermined value b2, the degree of opening SWBn is reduced to 0% (closed). The process controls the actuator 16 to allow the degree of opening of the bypass opening/closing damper 15 to approach the degree of opening SWBn determined in this way.

Then, as a blower mode, the control unit 4 automatically sets one mode of a bi-level mode, a face mode, and a foot mode in accordance with the required blower temperature TAO. More specifically, the face mode, the bi-level mode, and the foot mode are changed in that order as the required blower temperature TAO is increased.

During the bi-level mode, the actuator 18 controls the passageway opening/closing damper 17 to open all of the passageway 7 and the passageways 6, 76. Explaining briefly the operation in this case, the airflow that is blown from the air blower 3 and then cooled in the evaporator 8 is branched at the bypass opening/closing damper 15 to an airflow flowing into the cool-air bypass passageway 14 and an airflow flowing into the main passageway 5.

Subsequently, the airflow introduced into the main passageway 5 is branched at the air mix damper 12 to an airflow flowing into the heat control bypass passageway 11 and an airflow flowing into the heater core 9. This airflow is overheated at the heater core 9, and the overheated airflow is then mixed with the airflow passing through the heat control bypass passageway 11. The mixed airflow is then introduced into the passageways 6, 7, and 76.

In the passageway 6, the airflow is temperature controlled by the auxiliary heater 61a and the auxiliary cooling device 62a. Then, the process allows the airflow rate control damper 120 to branch this airflow to an airflow flowing into the passageway 6a and an airflow flowing into the passageway 6b. The airflow introduced into the passageway 6a is blown out of the face blower opening 100, while the airflow introduced into the passageway 6b is blown out of the armrest blower opening 100f.

In the passageway 7, the airflow is temperature controlled by the auxiliary heater 61b and the auxiliary cooling device 62b. The airflow is then blown out of the foot blower opening 100c.

In the passageway 76, the airflow having passed through the cool-air bypass passageway 14 and the airflow introduced from the main passageway 5 are mixed, and the mixed airflow is then temperature controlled by the auxiliary heater 61c. The process then allows the airflow rate control damper 123 to branch this airflow to an airflow flowing into the passageway 76a and an airflow flowing into the passageway 76b. The airflow flowing into the passageway 76a is blown out of the ceiling blower opening 100e, while the airflow flowing into the passageway 76b is blown out of the side-window blower opening 100d.

The process allows the actuator 18 to control the passageway opening/closing damper 17 to close the passageway 7 and open the passageways 6, 76 during the face mode but not during the bi-level mode.

Like in the bi-level mode, this allows the airflow to be blown out of each of the ceiling blower opening 100e, the side-window blower opening 100d, the face blower opening 100, and the armrest blower opening 100f. However, since the passageway 7 is closed, no airflow is introduced from the main passageway 5 into the passageway 7, resulting in no airflow being blown out of the foot blower opening During the foot mode, the process allows the actuator 16 to control the bypass opening/closing damper 15 to close the cool-air bypass passageway 14 as well as the actuator 18 to control the passageway opening/closing damper 17 to open the passageway 7 and close the passageways 6, 76. This allows the airflow having been introduced from the main passageway 5 into the passageway 7 to be temperature controlled by the auxiliary heater 61b and the auxiliary cooling device 62b, and the temperature controlled airflow is blown out of the foot blower opening 100c. However, since the passageways 6, 14 are closed, no airflow is blown out of each of the ceiling blower opening 100e, the side-window blower opening 100d, the face blower opening 100, and the armrest blower opening 100f.

Now, the temperature distribution correction processing performed by the control unit 4 will be described with reference to FIGS. 8 to 10. First, settings are made such that each region (more than one region) sensed by the non-contact temperature sensor 50 has a predetermined temperature distribution (S300 in FIG. 8). More specifically, the settings are made such that the average target temperature of the regions sensed by the infrared sensor elements FrDr2, 6 is equal to 23±1.5° C., the average target temperature of the regions sensed by the infrared sensor elements FrDr3, 7 is equal to 23±1.5° C., the average target temperature of the regions sensed by the infrared sensor elements FrDr4, 8 is equal to 23±1.5° C., and the average target temperature of the regions sensed by the infrared sensor elements FrDr10, 11, 14, 15 is equal to 25±1.5° C.

Then, the process permits the actuator 121 to control the airflow rate control damper 120 such that the airflows from the face blower opening 100 and the armrest blower opening 100f are blown at a ratio of 70% and a ratio of 30%, respectively. Furthermore, the process permits the actuator 122 to control the airflow rate control damper 123 such that the airflows from the ceiling blower opening 100e and the side-window blower opening 100d are blown at a ratio of 50% and a ratio of 50%, respectively (S310).

Then, the process determines the average value of the temperatures sensed by each of the infrared sensor elements FrDr10, 11, 14, and 15. In accordance with this average value and the temperature characteristics having hysteresis for preventing control hunting as shown by symbol 500 in FIG. 8, the process determines whether there is a disturbance in a predetermined temperature distribution formed over the infrared sensor elements FrDr2, 3, 4, 6, 7, 8, 10, 11, 14, and 15 (hereinafter simply referred to as the predetermined temperature distribution).

For example, when the average value of the aforementioned temperatures sensed by each sensor element lies in the intermediate range (23.5° C. to 26.5° C.), the process determines that there is no disturbance in the predetermined temperature distribution and then proceed to S340(1). On the other hand, when the average value of the aforementioned temperatures sensed by each sensor element is out of the intermediate range, the process determines that there is a disturbance in the predetermined temperature distribution and then proceed to S330(0).

In this case, the process determines the temperature difference between the average value of the temperatures sensed by each of the infrared sensor elements FrDr10, 11, 14, 15 and an average target temperature (e.g., 25° C.) (the average value−the average target temperature). Then, in accordance with this temperature difference (the average value−the average target temperature), the process allows the actuator 13 to correct the degree of opening SW of the air mix damper 12.

More specifically, as shown by the characteristics indicated by symbol 501 in FIG. 8, the process makes a correction in a manner such that the degree of opening SW approaches from the “target value+20%” to the “target value−20%” as the temperature difference (the average value−the average target temperature) increases. The “target value” refers to the value of the degree of opening determined in accordance with the Equation 2 described above, and “20%” is a ratio of degree of opening with the target value of the degree of opening SW determined as in the aforementioned Equation 2 being set at 100%.

Such a correction is made to the degree of opening SW at predetermined time intervals (e.g., 250 msec). In this way, the process controls the temperature of airflow blown from the face blower opening 100 located near the regions sensed by each of the infrared sensor elements FrDr10, 11, 14, 15, thereby allowing the temperature sensed by each of the infrared sensor elements FrDr10, 11, 14, 15 to approach the target average value.

Then, in S340, the process determines the average value of the temperatures sensed by each of the infrared sensor elements FrDr2, 6. It is then determined whether there is a disturbance in the predetermined temperature distribution, in accordance with this average value and the temperature characteristics having hysteresis for preventing the control hunting as shown by symbol 502 in FIG. 8.

For example, suppose that the process has determined that there is a disturbance in the predetermined temperature distribution because the temperatures sensed by the infrared sensor elements FrDr2, 6 are lower than the average target temperature and the process then proceeds to S370(0). In this case, the process allows the actuator 122 to control the airflow rate control damper 123 such that the airflows from the ceiling blower opening 100e and the side-window blower opening 100d are blown at a ratio of 40% and a ratio of 60%, respectively.

This allows for increasing the ratio of the airflow rate provided by the side-window blower opening 100d located near the regions sensed by each of the infrared sensor elements FrDr2 and 6.

Subsequently, in S380, the process controls the auxiliary heater 61c in accordance with the average value of the temperatures sensed by each of the infrared sensor elements FrDr2, 6 and the average target temperature (23° C.) (S380).

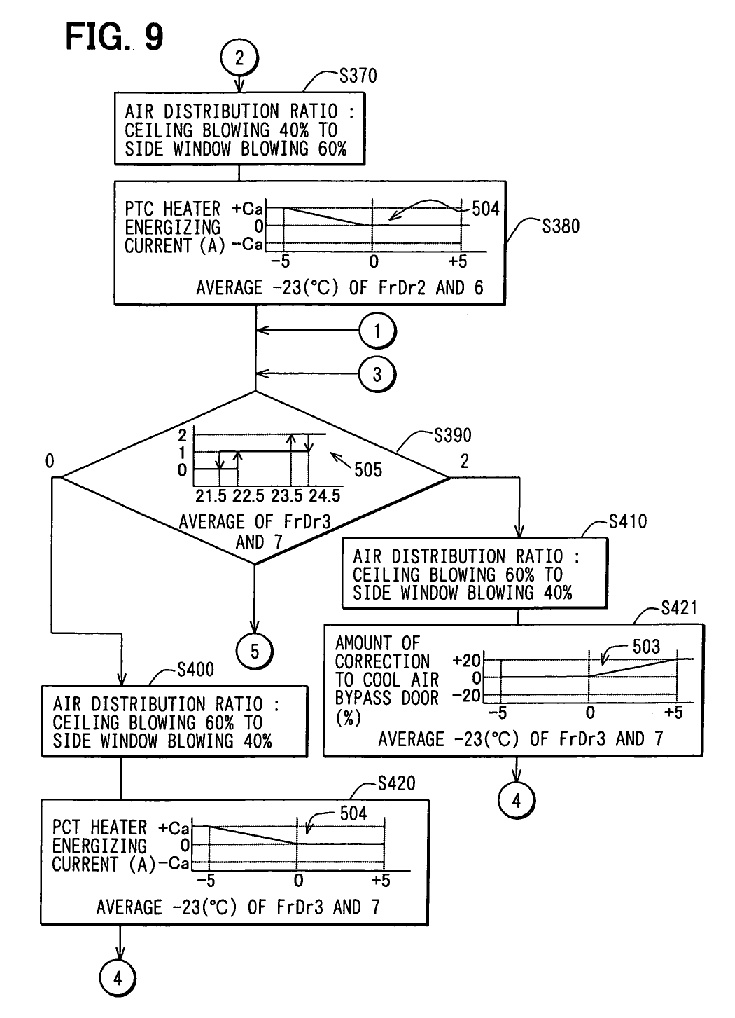

More specifically, the control is provided such that the current flowing through the auxiliary heater 61c is reduced from a predetermined amount of “+Ca” to a predetermined amount of “0” as the temperature difference between the average value and the average target temperature (23° C.) (the average value−the average target temperature) approaches from “−5” to “0” as shown by symbol 504 in FIG. 9.

The auxiliary heater 61c is controlled in this way, thereby increasing or decreasing the quantity of heat for heating an airflow passing through the passageway 76. This is accompanied by an increase in the temperature of the airflow blown from the side-window blower opening 100d located near the regions sensed by each of the infrared sensor elements FrDr2, 6. Accordingly, this allows the temperature sensed by each of the infrared sensor elements FrDr2, 6 to approach each average target temperature. Thereafter, the process proceeds to S390.

On the other hand, in S340 mentioned above, suppose that the process has determined that there is a disturbance in the predetermined temperature distribution because of the temperatures sensed by the infrared sensor elements FrDr2, 6 being higher than the average target temperature, and the process then proceeds to S350. In this case, like in S370 mentioned above, the process performs the airflow distribution ratio setting processing for setting “the ratio of airflow rate of the ceiling blower opening to 40% and that of the side-window blower opening to 60%.” This allows for increasing the ratio of airflow rate provided by the side-window blower opening 100d located near the regions sensed by the infrared sensor elements FrDr2 and 6.

In S360, the process then allows the actuator 16 to correct the degree of opening SWBn of the bypass opening/closing damper 15 (cool-air bypass door) in accordance with the average value of the temperatures sensed by each of the infrared sensor elements FrDr2, 6 and an average target temperature (23° C.). More specifically, a correction is made to increase the degree of opening SWBn of the bypass opening/closing damper 15 (cool-air bypass door) as the temperature difference between the average value and the average target temperature (23° C.) (the average value−the average target temperature) approaches from “0” to “−5” as shown by symbol 503 in FIG. 8.

For example, as indicated by symbol 503 in FIG. 8, the degree of opening SWBn is increased from the target value (which has been determined in accordance with TAO as described above) to the “target value+20%” as the temperature difference (the average value−the average target temperature) approaches from “0” to “+5.” The “20%” is a ratio of degree of opening with the target determined as described above being set at 100%.

The degree of opening SWBn of the bypass opening/closing damper 15 (cool-air bypass door) is controlled in this way, thereby increasing the airflow (cooled air) flowing from the evaporator 8 into the passageway 76 through the cool-air bypass passageway 14. This is accompanied by a decrease in the temperature of the airflow flowing through the passageway 76, resulting in a decrease in the temperature of the airflow blown from the side-window blower opening 100d located near the regions sensed by the infrared sensor elements FrDr2, 6. This allows the temperatures sensed by the respective infrared sensor elements FrDr2 and 6 to approach the average target temperature.

Then, in S390, the process determines whether there is a disturbance in the predetermined temperature distribution in accordance with the average value of the temperatures sensed by the respective infrared sensor elements FrDr3, 7 and the temperature characteristics having hysteresis for preventing control hunting as shown by symbol 505 in FIG. 9. For example, suppose that the process has determined that there is a disturbance in the predetermined temperature distribution because of the temperatures at the regions sensed by the infrared sensor elements FrDr3, 7 being lower than the average target temperature, and thus the process proceeds to S400(0). In this case, the process allows the actuator 122 to control the airflow rate control damper 123 such that the ratio between the airflow rate provided by the ceiling blower opening 100e and that provided by the side-window blower opening 100d is 40:60 on a percentage basis. This allows the ceiling blower opening 100e located near the regions sensed by the infrared sensor elements FrDr3 and 7 to supply airflow at an increased ratio of airflow rate.

Then, in accordance with the average value of the temperatures sensed by the respective infrared sensor elements FrDr3, 7 and the average target temperature (23° C.), the process controls the auxiliary heater 61c as shown by symbol 503 in FIG. 9 (S420). This causes the airflow passing through the passageway 76 to be overheated and the temperature of the airflow blown from the ceiling blower opening 100e located near the infrared sensor elements FrDr3, 7 to be increased, thereby allowing the temperatures sensed by the respective infrared sensor elements FrDr3, 7 to approach the average target temperature. Thereafter, the process proceeds to S430.

On the other hand, suppose that the process has determined in S390 as described above that there is a disturbance in the predetermined temperature distribution because of the temperatures sensed at the regions by the infrared sensor elements FrDr3, 7 being higher than the average target temperature, and thus the process proceeds to S410(2). In this case, like in the processing of S400, the process allows the actuator 122 to control the airflow rate control damper 123 such that the ratio between the airflow rate provided by the ceiling blower opening 100e and that provided by the side-window blower opening 100d is 60:40 on a percentage basis.

Then, in S421, like in the processing of S360, the process allows the actuator 16 to correct the degree of opening SWBn of the bypass opening/closing damper 15 (cool-air bypass door) in accordance with the temperature difference between the average value of the temperatures sensed by the respective infrared sensor elements FrDr3, 7 and a average target temperature (23° C.) (the average value−the average target temperature), and the characteristics shown by symbol 503 in FIG. 9. This causes the temperature of the airflow blown from the ceiling blower opening 100e located near the infrared sensor elements FrDr3, 7 to be controlled, thereby allowing the temperatures sensed by the respective infrared sensor elements FrDr3, 7 to approach the average target temperature.

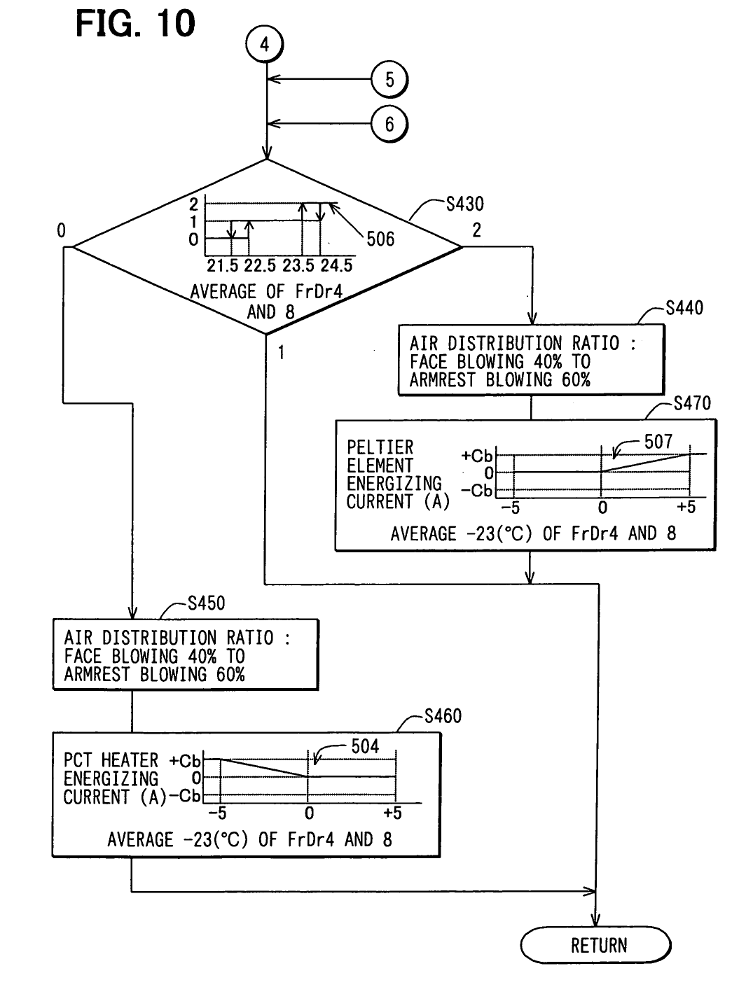

Then, in S430, the process determines whether there is a disturbance in the predetermined temperature distribution, in accordance with the average value of the temperatures sensed by the respective infrared sensor elements FrDr4, 8 and the temperature characteristics having hysteresis for preventing control hunting as shown by symbol 506 indicated in FIG. 10.

For example, suppose that the process has determined that there is a disturbance in the predetermined temperature distribution because of the temperatures sensed by the infrared sensor elements FrDr4, 8 being lower than the average target temperature, and then the process proceeds to S450(0). In this case, the process allows the actuator 121 to control the airflow rate control damper 120 such that the ratio between the airflow rate provided by the face blower opening 100 and that provided by the armrest blower opening 100f is 40:60 on a percentage basis. This allows the armrest blower opening 100f located near the infrared sensor elements FrDr4 and 8 to supply airflow at an increased ratio of airflow rate.

Then, in S460, like in the case of S380, the process controls the auxiliary heater 61a as shown by symbol 504 in FIG. 10 in accordance with the temperature difference between the average value of the temperatures sensed by the respective infrared sensor elements FrDr4, 8 and a average target temperature (23° C.) (the average value−the average target temperature). This causes the temperature of the airflow blown from the armrest blower opening 100f located near the infrared sensor elements FrDr4, 8 to be controlled, thereby allowing the temperatures sensed by the respective infrared sensor elements FrDr4, 8 to approach the average target temperature.

On the other hand, suppose that the process has determined in S430 as described above that there is a disturbance in the predetermined temperature distribution because of the temperatures sensed by the infrared sensor elements FrDr4, 8 being higher than the average target temperature, and the process then proceeds to S440(2). In this case, the process allows the actuator 122 to control the airflow rate control damper 123 such that the ratio between the airflow rate provided by the face blower opening 100 and that provided by the armrest blower opening 100f is 40:60 on a percentage basis.

Subsequently, in S470, the process controls the value of the current flowing through the auxiliary heater 61a in accordance with the temperature difference between the average value of the temperatures sensed by the respective infrared sensor elements FrDr4, 8 and an average target temperature (23° C.) (the average value the average target temperature). More specifically, the process allows the current flowing through the auxiliary heater 61a to approach from a predetermined value “+Cb0” to “0” as the temperature difference (the average value−the average target temperature) approaches from “−5” to “0,” in accordance with the characteristic diagram indicated by symbol 504 in FIG. 10. This causes the amount of heat absorbed from the airflow passing through the passageway 6 to be reduced as the temperature difference approaches from “−5” to “0.”

Since heat is absorbed from the airflow passing through the passageway 6 in this way, the temperature of the airflow blown from the armrest blower opening 100f located near the infrared sensor elements FrDr4, 8 is reduced. This in turn makes it possible for the temperatures sensed by the infrared sensor elements FrDr4, 8 to approach the average target temperature.

Now, the features of this embodiment will be described below. Namely, the control unit 4 allows the non-contact temperature sensor 50 to sense in a non-contact manner the temperatures at the surfaces of a plurality of regions on the upper body of the driver in the passenger compartment. In accordance with the temperatures sensed at each region by the non-contact temperature sensor 50, it is then possible to control the ratio of flow rate or the blower temperature of conditioned air supplied from a blower opening located near the region having a disturbance in the predetermined temperature distribution such as the face blower opening 100, the armrest blower opening 100f, the foot blower opening 100c, the ceiling blower opening 100e or the side-window blower opening 100d. This makes it possible to eliminate a disturbance in the predetermined temperature distribution over the plurality of regions.

Furthermore, in this embodiment, to realize a predetermined temperature distribution as instructed by a passenger, control is provided to the ratio of flow rate or the blower temperature of conditioned air blown from the face blower opening 100, the armrest blower opening 100f, the foot blower opening 100c, the ceiling blower opening 100e, and the side-window blower opening 100d. For example, this allows for setting a temperature distribution in accordance with a passenger's desired air speed or the feeling of temperature on the face set by a passenger, thereby making it possible to realize a target conditioned space by a passenger's setting.

[Second Embodiment]

A second embodiment is different from the aforementioned first embodiment in that control is provided variably to an auxiliary heater (PTC heater), an auxiliary cooling device (a Peltier element), and the bypass opening/closing damper 15 (cool-air bypass door) in accordance with a passenger's desired preference for “air speed feeling.”

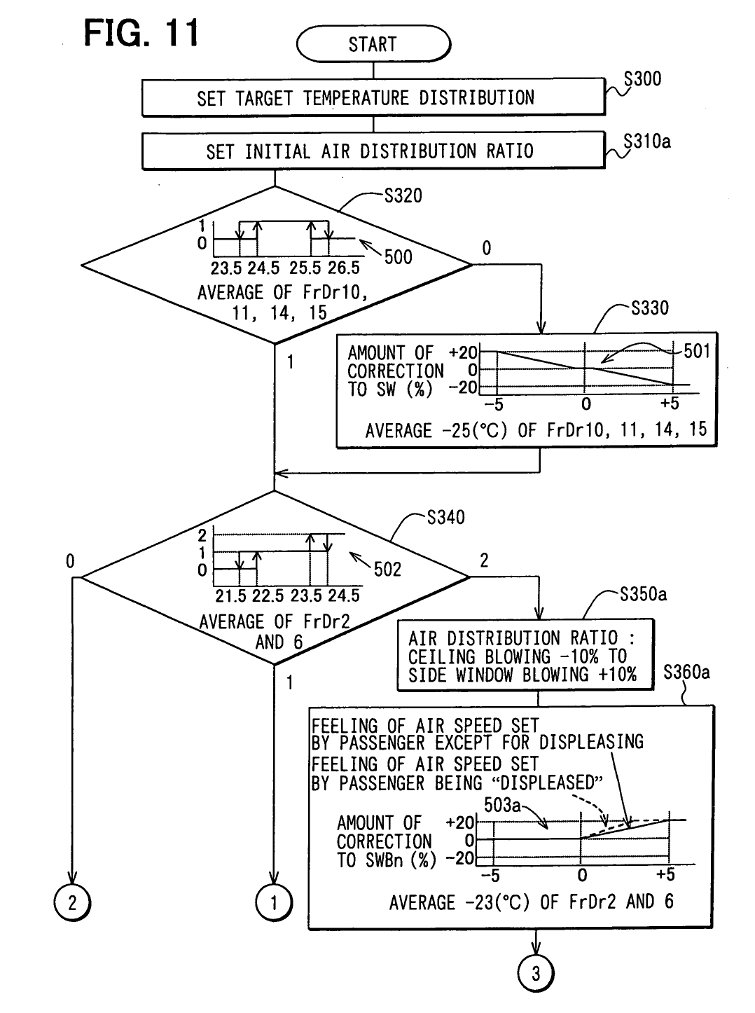

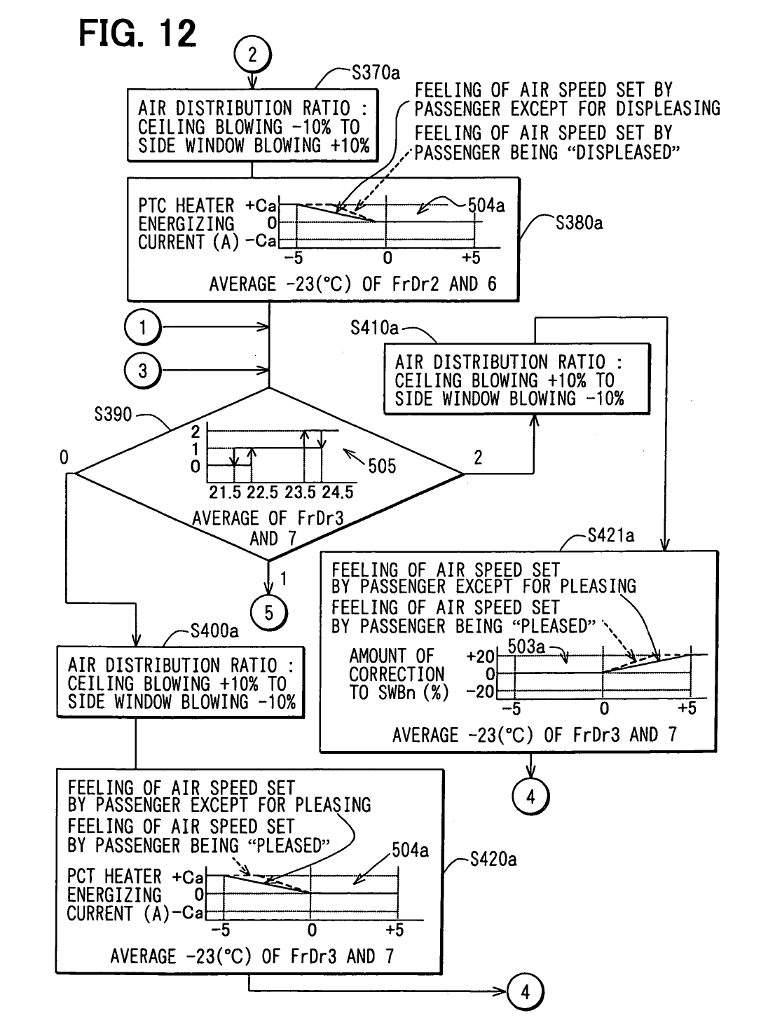

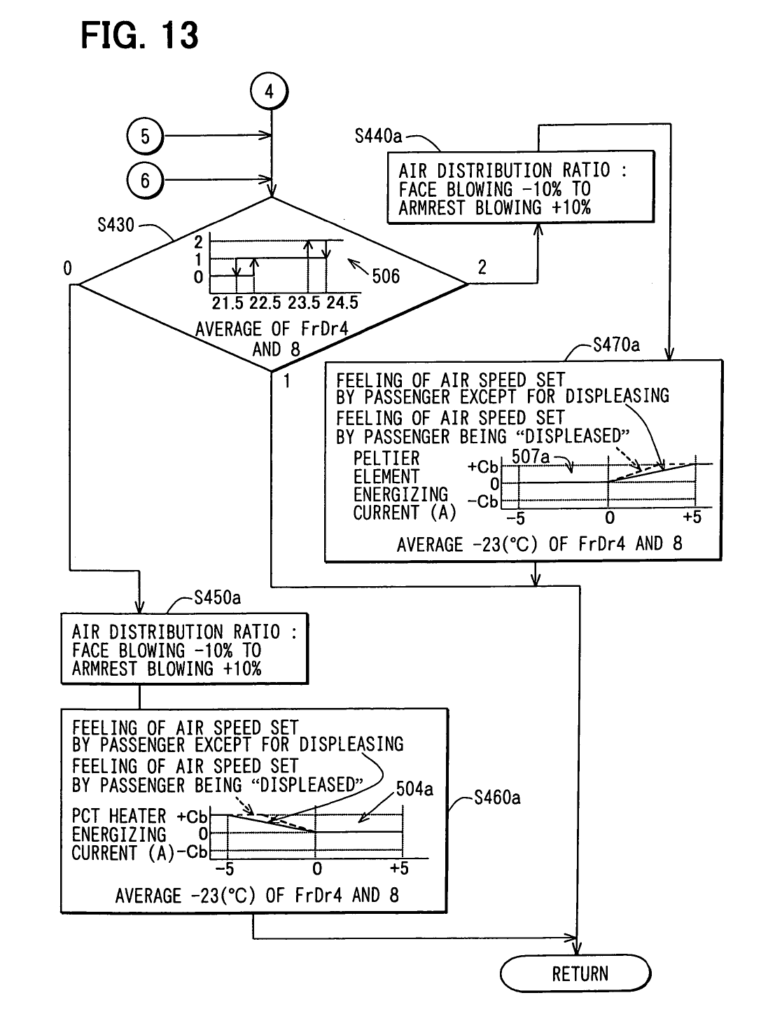

A control unit 4 according to this embodiment performs the temperature distribution correction processing in accordance with the flowcharts shown in FIGS. 11 to 13 instead of those shown in FIGS. 8 to 10. In FIGS. 11 to 13, the steps indicated by the same symbols as those of FIGS. 8 to 10 represent the same processing. Now, the temperature distribution correction processing according to this embodiment will be specifically described below.

After having set a predetermined temperature distribution (S300), the process proceeds to S310a, where an initial setting is provided to the air distribution ratio. Here, the process allows a passenger, more specifically, a driver to manually choose a desired air speed or to generally make a choice of the feeling of air speed (which means the feeling of air hitting the body) among “Displeased,” “Pleased,” or “No Preference.” For example, when the driver chooses “Displeased” as the desired air, the process provides the feeling of lower air speed to the driver.

More specifically, the process allows the actuator 121 to control the airflow rate control damper 120 so that the face blower opening 100 and the armrest blower opening 100f blow air at an initial ratio of 70:30 on a percentage basis, respectively. The process also allows the actuator 122 to control the airflow rate control damper 123 such that the ceiling blower opening 100e and the side-window blower opening 100d blow air at an initial ratio of 80:20 on a percentage basis, respectively.

Suppose that the driver makes “No Preference” the choice of air speed feeling. In this case, in order to provide the feeling of an intermediate air speed, the process allows the actuator 121 to control the airflow rate control damper 120 so that the face blower opening 100 and the armrest blower opening 100f blow air at an initial ratio of 50:50 on a percentage basis, respectively. The process also allows the actuator 122 to control the airflow rate control damper 123 such that the ceiling blower opening 100e and the side-window blower opening 100d blow air at an initial ratio of 70:30 on a percentage basis, respectively.

On the other hand, suppose that the driver makes “Pleased” the choice of air speed feeling. In this case, in order to provide the feeling of high air speed, the process allows the actuator 121 to control the airflow rate control damper 120 so that the face blower opening 100 and the armrest blower opening 100f blow air at an initial ratio of 30:70 on a percentage basis, respectively. The process also allows the actuator 122 to control the airflow rate control damper 123 such that the ceiling blower opening 100e and the side-window blower opening 100d blow air at an initial ratio of 50:50 on a percentage basis, respectively.

Setting the feeling of lower air speeds as described above will cause the face blower opening 100 of the face blower opening 100 and the armrest blower opening 100f located farther from the passenger to increase its ratio of airflow rate, and the armrest blower opening 100f located nearer to the passenger to decrease its ratio of airflow rate. Furthermore, setting the feeling of lower air speeds will cause the ceiling blower opening 100e of the ceiling blower opening 100e and the side-window blower opening 100d having a larger blower area (opening area) to increase its ratio of airflow rate and the side-window blower opening 100d having a smaller blower area to decrease its ratio of airflow rate. In this way, when desiring the feeling of lower air speed, the passenger is provided with the feeling of lower speed of the conditioned air.

Then, the process determines whether there is a disturbance in the temperature distribution (S320), corrects the degree of opening SW (S330), and determines whether there is a disturbance in the temperature distribution (S340). Suppose that the process then proceeds from the determination processing (S340) to S350a. In this case, the process allows the actuator 122 to control the airflow rate control damper 123 in order to reduce the ratio of airflow rate provided by the ceiling blower opening 100e from the initial value by a predetermined ratio (e.g., 10%) while increasing the ratio of airflow rate provided by the side-window blower opening 100d by a predetermined ratio (e.g., 10%).

Then, the process proceeds to S360a, where the actuator 16 corrects the degree of opening SWBn of the bypass opening/closing damper 15 (cool-air bypass door) in accordance with the temperature difference between the average value of the temperatures sensed by the respective infrared sensor elements FrDr2, 6 and a average target temperature (23° C.) (the average value−the average target temperature). More specifically, as the temperature difference increases, the degree of opening SWBn of the bypass opening/closing damper 15 (cool-air bypass door) is increased in accordance with the characteristics (the temperature difference−the amount of correction to the degree of opening SWBn) indicated by symbol 503a in FIG. 8.

Here, when “No Preference” or “Pleased” is selected as the feeling of air speed, like in the aforementioned first embodiment, the degree of opening SWBn of the bypass opening/closing damper 15 (cool-air bypass door) is corrected in accordance with the characteristics (indicated by the symbol 503a in solid lines). On the other hand, when “Displeased” is selected as the feeling of air speed, the degree of opening SWBn is corrected using the characteristics (indicated by dotted lines) having a steeper gradient of the degree of opening SWBn against the temperature difference when compared with the case of “No Preference” or “Pleased” being selected. When “Displeased” is selected as the feeling of air speed, this allows the increase in blower ratio of the side-window blower opening 100d (which provides the feeling of high air speed) to be achieved at an earlier stage when compared with the case of “No Preference” or “Pleased” being selected.

On the other hand, suppose that the process proceeds to S370a after having determined whether there is a disturbance in the temperature distribution (S340). In this case, like in S350a, the process allows the actuator 122 to control the airflow rate control damper 123 in order to reduce the ratio of airflow rate provided by the ceiling blower opening 100e from the initial value by a predetermined ratio (e.g., 10%) while increasing the ratio of airflow rate provided by the side-window blower opening 100d by a predetermined ratio (e.g., 10%).

Then, the process controls the auxiliary heater 61c as shown by symbol 503a in accordance with the temperature difference between the average value of the temperatures sensed by the respective infrared sensor elements FrDr2, 6 and an average target temperature (23° C.) (the average value−the average target temperature) (S380a). This is accompanied by an increase in the temperature of the airflow blown from the ceiling blower opening 100e located near the infrared sensor elements FrDr2, 6, thereby allowing the temperatures sensed by the respective infrared sensor elements FrDr3 and 7 to approach the average target temperature.

Here, the characteristics (dotted lines) of the amount of correction to the degree of opening SWBn against the temperature difference provided when “Displeased” is selected as the feeling of air speed are steeper than the characteristics (solid lines) of the amount of correction to the degree of opening SWBn against the temperature difference provided when “No Preference” or “Pleased” is selected. Accordingly, when “Displeased” is selected as the feeling of air speed, this allows the increase in the blower ratio of the side-window blower opening 100d (which provides the feeling of high air speed) to be achieved at an earlier stage when compared with the case of “No Preference” or “Pleased” being selected.

On the other hand, suppose that the process proceeds to S400a after having determined whether there is a disturbance in the temperature distribution (S390). In this case, the process permits the actuator 122 to control the airflow rate control damper 123 in order to increase the ratio of airflow rate provided by the ceiling blower opening 100e from the initial value by a predetermined ratio (e.g., 10%) while reducing the ratio of airflow rate provided by the side-window blower opening 100d by a predetermined ratio (e.g., 10%).

Then, the process controls the auxiliary heater 61c as shown by symbol 504a in accordance with the temperature difference between the average value of the temperatures sensed by the respective infrared sensor elements FrDr3, 7 and an average target temperature (23° C.) (the average value−the average target temperature) (S420a). This is accompanied by an increase in the temperature of the airflow blown from the ceiling blower opening 100e located near the infrared sensor elements FrDr2, 6, thereby allowing the temperatures sensed by the respective infrared sensor elements FrDr3 and 7 to approach the average target temperature.

Here, the characteristics (dotted lines) of the current flowing through the auxiliary heater 61a against the temperature difference provided when “Displeased” is selected as the feeling of air speed are steeper than the characteristics (solid lines) of the current flowing through the auxiliary heater 61a against the temperature difference provided when “No Preference” or “Pleased” is selected. When “Displeased” is selected as the feeling of air speed, this allows the increase in the blower ratio of the ceiling blower opening 100e (which provides the feeling of high air speed) to be achieved at an earlier stage when compared with the case of “No Preference” or “Pleased” being selected.

On the other hand, suppose that the process proceeds to S370a after having determined whether there is a disturbance in the temperature distribution (S390). In this case, like in S410a, the process allows the actuator 122 to control the airflow rate control damper 123 in order to increase the ratio of airflow rate provided by the ceiling blower opening 100e from the initial value by a predetermined ratio (e.g., 10%) while reducing the ratio of airflow rate provided by the side-window blower opening 100d by a predetermined ratio (e.g., 10%).

Then, in S421a, the process allows the actuator 16 to correct the degree of opening SWBn of the bypass opening/closing damper 15 according to the characteristics (solid and dotted lines) as indicated by symbol 504a, in accordance with the temperature difference between the average value of the temperatures sensed by the respective infrared sensor elements FrDr3, 7 and the average target temperature (the average value−the average target temperature) (S420a). This is accompanied by a decrease in the temperature of the airflow blown from the ceiling blower opening 100e located near the infrared sensor elements FrDr3, 7.

Like in S360a, when “Displeased” is selected here as the feeling of air speed, the process allows the actuator 16 to correct the degree of opening SWBn of the bypass opening/closing damper 15 so that the increase in the blower ratio provided by the ceiling blower opening 100e is achieved at an earlier stage when compared with the case of “No Preference” or “Pleased” being selected.

On the other hand, suppose that the process proceeds to S450a after having determined whether there is a disturbance in the temperature distribution (S430). In this case, the process allows the actuator 121 to control the airflow rate control damper 120 in order to reduce the ratio of airflow rate provided by the face blower opening 100 from the initial value by a predetermined ratio (e.g., 10%) while increasing the ratio of airflow rate provided by the armrest blower opening 100f by a predetermined ratio (e.g., 10%).

Then, the process controls the auxiliary heater 61c as shown by symbol 504a in accordance with the temperature difference between the average value of the temperatures sensed by the respective infrared sensor elements FrDr4, 8 and an average target temperature (23° C.) (the average value−the average target temperature) (S420a). This is accompanied by a decrease in the temperature of the airflow blown from the armrest blower opening 100f located near the infrared sensor elements FrDr4, 8.

When “Displeased” is selected here as the feeling of air speed, like in S380a, the process controls the current flowing through the auxiliary heater 61a so that the increase in the blower ratio provided by the armrest blower opening 100f is achieved at an earlier stage when compared with the case of “No Preference” or “Pleased” being selected.

Suppose that the process then proceeds to S440a after having determined as described above whether there is a disturbance in the temperature distribution (S430). In this case, like in S450a, the process allows the actuator 121 to control the airflow rate control damper 120. This is accompanied by providing control to the value of current (energizing current) flowing through the auxiliary cooling device 62a in accordance with the temperature difference between the average value of the temperatures sensed by the respective infrared sensor elements FrDr4, 8 and the average target temperature (the average value−the average target temperature). This allows the temperature of the airflow blown from the armrest blower opening 100f located near the infrared sensor elements FrDr4 and 8 to be decreased.

Here, the characteristics (dotted lines) of the current flowing through the auxiliary cooling device 62a against the temperature difference provided when “Displeased” is selected as the feeling of air speed are steeper than the characteristics (solid lines) of the current flowing through the auxiliary cooling device 62a against the temperature difference provided when “No Preference” or “Pleased” is selected. When “Displeased” is selected as the feeling of air speed, this allows the increase in the blower ratio of the armrest blower opening 100f to be achieved at an earlier stage when compared with the case of “No Preference” or “Pleased” being selected.

[Third Embodiment]

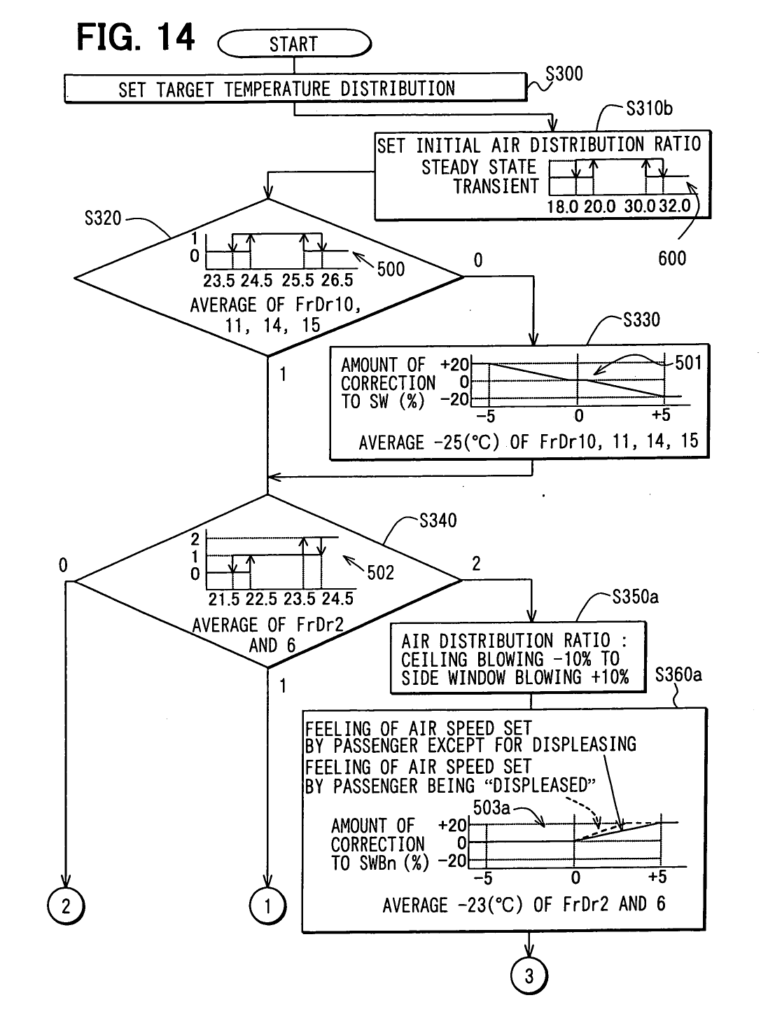

Referring to FIGS. 14-16, a third embodiment of the process will be discussed. In the third embodiment, the process eliminates a disturbance in the predetermined temperature distribution at the driver seat using the airflow from the center-grille blower opening 101a at the front passenger seat when no passenger occupies the front passenger seat.

A control unit 4 according to this embodiment performs the temperature distribution correction processing in accordance with the flowcharts shown in FIGS. 14 to 16 instead of those shown in FIGS. 11 to 13. In FIGS. 14 to 16, the steps indicated by the same symbols as those of FIGS. 8 to 13 represent the same processing.

In this embodiment, the center-grille blower opening 101a at the front passenger seat is provided with a swing louver (air directing plates) supported therein to variably change the direction of air blown out of the blower opening 101a. The process allows an actuator to swing the swing louver periodically to periodically change the direction of air from the front passenger seat to the driver seat. The specific structure of the swing louver, being the same as that disclosed in Japanese Patent Laid-Open Publication No. 2002-46446, is not repeatedly described. This embodiment also allows the control unit 4 to control the actuator as well as the air-conditioning system for the front passenger seat. The air-conditioning system for the front passenger seat is configured in the same manner as shown in FIG. 2.

Now, the temperature distribution correction processing provided by the aforementioned arrangement according to this embodiment is specifically described below.

First, after having set a predetermined temperature distribution (S300), the process proceeds to S310b, where an initial setting is provided to the air distribution ratio. Here, the process allows the driver to manually make a choice of the feeling of air speed among “Displeased,” “Slightly Displeased,” “Pleased,” or “No Preference.”

For example, suppose that the driver selects “Displeased,” “Pleased,” or “No Preference” as the feeling of air speed. In this case, the process allows the actuator 121 to control the airflow rate control damper 120 so that the ratio of airflow rate between the face blower opening 100 and the armrest blower opening 100f agrees with the same initial value as that in S300. The process also allows the actuator 122 to control the airflow rate control damper 123 so that the ratio of airflow rate between the ceiling blower opening 100e and the side-window blower opening 100d agrees with the same initial value as that given through the processing in S310a as described with reference to the aforementioned second embodiment.

On the other hand, suppose that the driver makes “Slightly Displeased” the choice of air speed feeling. In this case, the process allows the actuator 121 to control the airflow rate control damper 120 so that the face blower opening 100 and the armrest blower opening 100f blow air at an initial ratio of 60:40 on a percentage basis, respectively. The process also allows the actuator 122 to control the airflow rate control damper 123 such that the ceiling blower opening 100e and the side-window blower opening 100d blow air at an initial ratio of 90:10 on a percentage basis, respectively.

When “Displeased” is selected here as the feeling of air speed, the process sets to “30%” the ratio of time during which the swing louver keeps directing the air flown out of the center-grille blower opening 101a at the front passenger seat toward the driver seat. The “30%” is a ratio with one cycle of a swing operation of the swing louver being set at 100%. On the other hand, when “Slightly Displeased” is selected as the feeling of air speed, the process sets to “20%” the ratio of time during which the swing louver keeps directing the air flown out of the center-grille blower opening 101a at the front passenger seat toward the driver seat.

Furthermore, in accordance with the average value of the surface temperatures sensed by the respective infrared sensor elements FrDr2, 3, 4, 6, 7, 8, 10, 11, 14, and 15, the process determines according to the characteristics indicated by symbol 600 in FIG. 14 whether the control over air conditioning is in a transient period or in a steady state period. More specifically, the process determines that the control is in the steady state period when the aforementioned average value of the respective sensed surface temperatures lies within the intermediate range (18° C. to 32° C.), and determines that the control is in the transient period when the aforementioned average value is out of the intermediate range.

When having determined that the control over air conditioning is in the transient period, the process allows the actuator 121 to control the airflow rate control damper 120 in order to reduce the ratio of airflow rate provided by the face blower opening 100 from the initial value by a predetermined value (e.g., 10%) while increasing the ratio of airflow rate provided by the armrest blower opening 100f by a predetermined value (e.g., 10%). The process also allows the actuator 122 to control airflow rate control damper 123 in order to reduce the ratio of airflow rate provided by the ceiling blower opening 100e from the initial value by a predetermined value (e.g., 10%) while increasing the ratio of airflow rate provided by the side-window blower opening 100d from the initial value.

In this way, when the control over air conditioning is in the transient period, the process increases the ratio of airflow rate provided by the armrest blower opening 100f, of the face blower opening 100 and the armrest blower opening 100f having a shorter airflow passageway. At this time, the process also increases the ratio of airflow rate provided by the side-window blower opening 100d, of the ceiling blower opening 100e and the side-window blower opening 100d, having a shorter airflow passageway. This allows for reducing heat loss through the airflow passageway, thereby making it possible to shorten the time required to reach the target conditioning state.

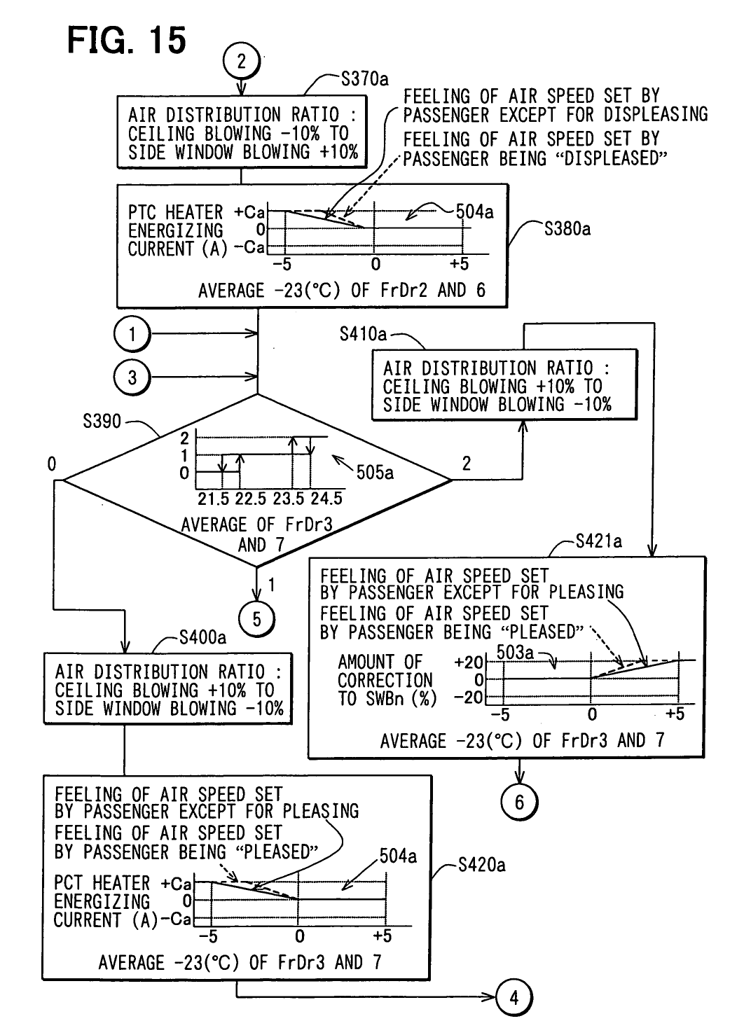

Thereafter, like in the aforementioned second embodiment, the process determines whether there is a disturbance in the predetermined temperature distribution (S320), corrects the degree of opening SW (S330), determines whether there is a disturbance in the predetermined temperature distribution (S340), sets an air distribution ratio (S350a), corrects the degree of opening of the cool-air bypass door (S360a), sets an air distribution ratio (S370a in FIG. 15), controls the auxiliary heater (S380a in FIG. 15), determines whether there is a disturbance in the predetermined temperature distribution (S390 in FIG. 15), sets an air distribution ratio (S400a in FIG. 15), controls the auxiliary heater (S420a in FIG. 15), sets an air distribution ratio (S410a in FIG. 15), and corrects the degree of opening of the cool-air bypass door (S421a in FIG. 15). Thereafter, the process proceeds to S600A.

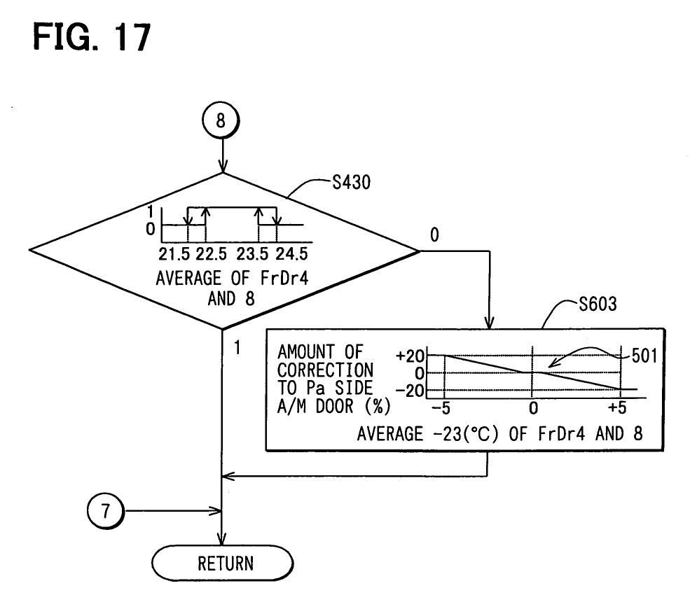

When “Slightly Displeased” or “Displeased” is selected as the feeling of air speed, the process proceeds to determine whether there is a disturbance in the predetermined temperature distribution (S430) as shown in FIG. 17. Having determined that there is a disturbance in the temperature distribution over the regions sensed by the infrared sensor elements FrDr4 and 8 in accordance with the average value of the temperatures sensed by the respective infrared sensor elements FrDr4, 8, the process allows the actuator 15 at the front passenger seat to correct the degree of opening SW of the air mix damper 12 in accordance with the average target temperature of the infrared sensor elements FrDr4, 8 and the temperature difference (the average value−the average target temperature).

More specifically, as shown by the characteristics indicated by symbol 501 in FIG. 17, the process allows the actuator 15 at the front passenger seat to increase the degree of opening SW of the air mix damper 12 as the temperature difference (the average value−the average target temperature) increases. Since the degree of opening SW is corrected as described above, the temperature of airflow blown from the center-grille blower opening 101a at the front passenger seat is controlled, and the controlled airflow is blown to the driver from the center-grille blower opening 101a at the front passenger seat. Accordingly, the temperatures sensed by the respective infrared sensor elements FrDr4, 8 are allowed to approach the target average value.

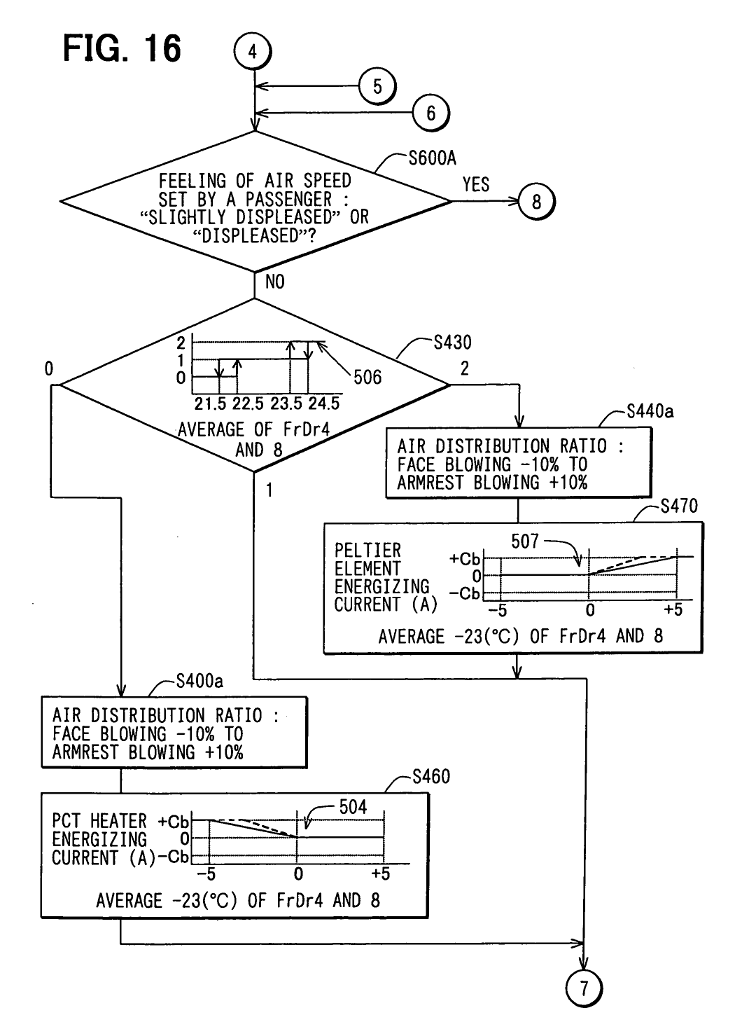

In S600 in FIG. 16, when “No Preference” or “Pleased” is selected as the feeling of air speed, the process determines whether there is a disturbance in the predetermined temperature distribution (S430), sets an air distribution ratio (S440a), controls the auxiliary heater (S460), sets an air distribution ratio (S400a), and performs the auxiliary cooling processing (S460a).

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A vehicle air-conditioning system comprising:
a non-contact temperature sensor for sensing temperatures of a plurality of regions in a passenger compartment in a non-contact manner; and
control means for controlling one of a ratio of flow rate and a blower temperature of conditioned air blown out of a plurality of blower openings to provide a predetermined temperature distribution for the plurality of regions in accordance with the temperatures of the plurality of regions sensed by the non-contact temperature sensor.

2. The vehicle air-conditioning system according to claim 1, wherein the control means further provides the temperature distribution for the plurality of regions based upon a passenger instruction.

3. The vehicle air-conditioning system according to claim 1 or 2, wherein the control means controls one of the ratio of flow rate and the blower temperature of conditioned air blown out of a blower opening located near the region of the plurality of regions having a disturbance in the temperature distribution.

4. A vehicle air-conditioning system comprising:
a non-contact temperature sensor for sensing, in a non-contact manner, a temperature of a conditioned zone at an occupied seat in a passenger compartment; and
control means for controlling one of a ratio of flow rate and a blower temperature of conditioned air blown out of each of a plurality of blower openings to provide a predetermined temperature distribution for the conditioned zone at the occupied seat in accordance with the temperature at the occupied seat sensed by the non-contact temperature sensor.

5. The vehicle air-conditioning system according to claim 4, wherein:
the non-contact temperature sensor is designed to sense, also in the non-contact manner, the temperatures of the conditioned zone divided into a plurality of regions; and
the control means controls one of the ratio of flow rate and the blower temperature of conditioned air blown out of the blower opening located near a region of the plurality of regions having a disturbance in the temperature distribution.

6. The vehicle air-conditioning system according to any one of claims 1-2 and 4-5, wherein:
the control means further controls the ratio of flow rate in accordance with a setting provided by a passenger, the setting being indicative of one of a feeling of one of higher speed and lower speed of air blown out of the plurality of blower openings; and
wherein the feeling of lower air speed set by the passenger causes the ratio of flow rate provided by a blower opening of the plurality of blower openings, having a larger opening area to be increased.

7. The vehicle air-conditioning system according to any one of claims 1-2 and 4-5, wherein:
the control means further controls the ratio of flow rate in accordance with a setting provided by a passenger, the setting being indicative of one of a feeling of one of higher speed and lower speed of air blown out of the plurality of blower openings; and
wherein the feeling of lower air speed set by the passenger causes the ratio of flow rate provided by a blower opening of the plurality of blower openings located farther away from the passenger to be increased.

8. The vehicle air-conditioning system according to any one of claims 1-2 and 4-5, wherein:
the control means selects a blower opening having a shorter airflow passageway for conditioned air from the plurality of blower openings during a transient period in which the ratio of flow rate or the blower temperature of conditioned air is controlled; and
the control means controls the conditioned air to be blown from the selected blower opening.

9. A computer-readable recording medium storing a program for controlling a vehicle air-conditioning system, the program of the computer-readable recording medium when installed in a computer used as control means for the vehicle air-conditioning results in the vehicle air-conditioning system operating as follows:
a non-contact temperature sensor of the vehicle air-conditioning system senses temperatures at a plurality of regions in a passenger compartment; and
one of a ratio of flow rate and a blower temperature of conditioned air blown out of a plurality of blower openings of the vehicle air-conditioning system is controlled in accordance with the temperatures sensed at the plurality of regions to provide a predetermined temperature distribution over the plurality of regions.

10. The computer-readable recording medium of claim 9, wherein the conditioned air blown out of the plurality of blower openings is further controlled to provide the temperature distribution over the plurality of regions as instructed by a passenger.

11. A computer-readable recording medium storing a program for controlling a vehicle air-conditioning system, the program of the computer-readable recording medium when installed in a computer used as control means for the vehicle air-conditioning results in the vehicle air-conditioning system operating as follows:
a non-contact temperature sensor of the vehicle air-conditioning system senses in a non-contact manner a temperature of a conditioned zone at an occupied seat in a passenger compartment; and
one of a ratio of flow rate and a blower temperature of conditioned air blown out of a plurality of blower openings of the vehicle air-conditioning system is controlled in accordance with the temperature sensed at the occupied seat to provide a predetermined temperature distribution over the conditioned zone at the occupied seat.

12. A vehicle air-conditioning system for controlling a ratio of airflow rate from a blower opening, wherein the blower opening is disposed at least at one of an armrest blower opening, a ceiling blower opening and a side-window blower opening, wherein each blower opening is for blowing conditioned air to a driver and a driver's surrounding, the vehicle air-conditioning system comprising:
a non-contact temperature sensor for determining a surface temperature at each of a plurality of regions on the driver and the driver's surrounding;
means for calculating a required blower temperature (TAO) based upon at least a set point temperature provided by a temperature-setting device;
means for controlling a blower temperature control mechanism using the required blower temperature (TAO);
means for determining at least any blower mode of a face blower mode and a foot blower mode using the required blower temperature (TAO) to control the ratio of airflow rate provided by each blower opening in a passenger compartment depending on the blower mode;
means for storing a setting of a predetermined temperature distribution over the plurality of regions for the non-contact temperature sensor;
means for determining whether there is a disturbance in the predetermined temperature distribution, in accordance with a temperature sensed by the non-contact temperature sensor at a particular region of the plurality of regions; and
means for correcting a disturbance in the predetermined temperature distribution by controlling a temperature of air blown from at least any blower opening located near the particular region, of the armrest blower opening, the ceiling blower opening, and the side-window blower opening when it has been determined that there is a disturbance in the predetermined temperature distribution.

13. The vehicle air-conditioning system according to claim 12, wherein the blower openings in the passenger compartment are located in front of, at a side of, and above a passenger, respectively.

14. The vehicle air-conditioning system according to claim 12, wherein the means for determining whether there is a disturbance in the predetermined temperature distribution determines that there is a disturbance in the predetermined temperature distribution, in accordance with the temperature sensed at the particular region and data in a predetermined map when the temperature sensed at the particular region is out of a predetermined temperature range.

15. The vehicle air-conditioning system according to claim 12, wherein the means for correcting a disturbance in the predetermined temperature distribution increases an amount of air blown from at least any blower opening located near the particular region, of the armrest blower opening, the ceiling blower opening, and the side-window blower opening, when it has been determined that there is a disturbance in the predetermined temperature distribution.
